(19) United States
(12) Patent Application Publication
(10) Pub. No.: US 2019/0394595 A1
(43) Pub. Date: Dec. 26, 2019

(54) Membrane Plate Structure For Generating Sound Waves

(71) Applicant: 4A Manufacturing GmbH, Traboch (AT)

(72) Inventors: Domenico Foglia, Wien (AT); Michael Pichler, Kobenz (AT); Reinhard Hafellner, Spielberg (AT)

(21) Appl. No.: 16/092,879

(22) PCT Filed: Apr. 11, 2017
(86) PCT No.: PCT/EP2017/058684

§ 371 Date: Oct. 11, 2018

(30) Foreign Application Priority Data
Apr. 11, 2016 (GB) 1606119.4

(51) Int. Cl. H04R 31/00; H04R 7/10

(52) U.S. Cl. CPC H04R 31/003; H04R 7/10

(57) ABSTRACT

The present invention relates to a membrane plate structure for generating sound waves. The membrane plate structure includes a first skin layer, a second skin layer and a core layer which is interposed between the first skin layer and the second skin layer. At least one of the first skin layer and the second skin layer is attachable to a vibrating element for generating sound waves. The elastic modulus of the core layer and its density are lower than the elastic modulus and the density of the first skin layer and the second skin layer. The core layer is made of a material which is free of pores.

### TECHNICAL FIELD

The present invention relates to a membrane plate structure for generating sound waves and to a loudspeaker comprising the membrane plate structure.

### TECHNOLOGICAL BACKGROUND

Loudspeaker, in particular in micro-speakers for portable devices (mobile phones), and more in particular receiver micro-speaker (also called ear-pieces, responsible for the voice sound-transmission), may need thinner elements in order to reduce the overall size of the loudspeaker. In general, a loudspeaker comprises a diaphragm which is excited by a coil or another vibrating element.

In US 2013/0016874 A1 for example this function is represented by the element 121 of a diaphragm 12 which may guarantee high break-up frequency and low weight. This element is often called membrane plate, to be distinguished from the surround (connecting area 123) which is often called membrane. The characteristics required by a membrane plate may be:
a. High material resonance frequency—to guarantee a linearity and the absence of acoustic peaks in the hearable region
b. Low weight—to reduce the moved mass and consequently increase the sound pressure level and the efficiency of the speaker
c. High temperature resistance—to guarantee the same mechanical stiffness at higher working temperatures.

The resonance frequency of a material is directly proportional to its length and width and a figure of merit, here defined “Frequency Factor”. The frequency factor is defined as follow:

$$d \sqrt{\frac{B}{ρ}}$$

Where d, is the total thickness, B is the bending module, and ρ is the density of the membrane plate material. The square root is also the speed of sound of the material.

For these applications, due to the low available thickness, in order to achieve high frequency factors, it may be necessary to utilize high mechanical performance materials. Sandwich constructions may represent the best solution for this application, since they may offer the best ratio of bending module to weight (see also “An Introduction to Sandwich Construction”, Zenkert, D., 1995, Engineering Materials Advisory Services Ltd).

For these reasons, in micro-speaker applications, the actual state of the art is the use of a flat (or nearly flat) sandwich composite membrane plates, where the skin layers are aluminum foils between 8 and 20 μm, and the core layer is a very thin foam layer between 100 and 400 μm (disclosed for example in CN 204707266 U).

If this construction may be perfect for normal micro-speakers, for ear-piece speakers (called also receiver) it may not be functional, since the available space for membrane plates may be lower than 100 μm and the weight must be lower than 100 g/m².

In fact, the manufacture of the thin foam core layers may be extremely hard to achieve for thicknesses under 100 μm and may be expensive. For this reason, in receiver applications, the sandwich materials with a foam core may not be utilized, and the state of the art materials are bulk materials, like normal polyesters (PAR, PC, PET or PEN) or aluminum foils.

### SUMMARY

There may be a need to provide a component for a loudspeaker with very small space requirements.

According to a first aspect of the present invention, a membrane structure for generating sound waves is presented. The membrane plate structure comprises a first skin layer, a second skin layer and a core layer which is interposed between the first skin layer and the second skin layer and is acting as binding element between the two skin layers. The core layer could be constituted by one layer or by multiple, layers. For example, one of the skin layers is e.g. attachable to a vibrating element (such as a coil, a pieta element, a MEMS structure or an exciter) for generating sound waves. The young modulus of the core layer is lower than the young modulus of the first skin layer and the second skin layer. The density of the first skin layer and/or the second skin layer is higher than the density of the core layer. The core layer is made of a material(s) which is free of pores.

According to the present invention, the young modulus and the density of the core layer are lower than the young modulus and the density of the first membrane skin layer and the second membrane skin layer, wherein the core layer is made of a thin material which is free of pores and act as binding element between the two skin layers.

A material which is free of pores may denote a solid material which has no cavities or pause for enclosing air or other gas, for example. The material(s) of the core layer to the present, invention may have a low porosity or void fraction which is a measure of the void (i.e. “empty”) spaces in a material, and is a fraction of the volume of voids over the total volume. Specifically, the core layer material according to the present invention may have a density higher than 0.8 g/cm³ and voids smaller than 1 μm.

The core layer may be selected with a lower young modulus and a lower density than the surrounding membrane skin layers. Hence, the membrane plate construction is a so-called sandwich construction.

This sandwich construction may guarantee high resonance frequency of the material and low weight.

The advantages of using a free of pores material as a core layers may be:
Possibility of building sandwich materials with total thickness lower than 100 μm
Possibility of creating sandwich materials with total weight lower than 100 g/m²
Possibility of creating materials with high frequency factor at very low thickness and weight
Possibility of creating materials with high stiffness and/or high damping ratio
Possibility to create materials with high temperature resistances (high HDT)
Possibility to use low-cost materials both as skin layers and core layer.
Very easy manufacturing, suitable for mass-production.

According to a further aspect of the present invention, a micro speaker functioning as a loudspeaker is a receiver micro speaker.

The micro speaker may comprise a carrier element, a coil which is coupled to the carrier element by meaning of so-called surround or membrane and a membrane plate coupled with the coil for generating sound waves.

### OVERVIEW OF EMBODIMENTS

According to an exemplary embodiment, the sandwich material has a HOT (heat deflection temperature) higher than 80° C., in particular higher than 110° C., further in particular higher than 130° C.

According to an exemplary embodiment, the choice of ductile materials as skin layer and core layers allows the sandwich to be formable (e.g. by cold and warm forming). Such materials are ideally metals foils (especially aluminum) for skin layers and thermoplastic material as core layers.

According to an exemplary embodiment, the core layer is a plastic core layer. Plastic materials could range from thermosets, to thermoplastics, to elastomers.

According to an exemplary embodiment, the core layer comprises an elastic modulus of more than 10 MPa, in particular more than 100 MPa, further in particular more than 500 MPa.

According to an exemplary embodiment, the first membrane skin layer and/or the second skin layer comprises an elastic modulus of more than 10 GPa, in particular more than 30 GPa, further in particular more than 50 GPa.

According to an exemplary embodiment, the first membrane skin layer and/or the second skin layer is made of metal foil or aluminum foil, with a thickness equal or lower than 15 μm (Micrometer) per layer.

According to an exemplary embodiment, the core layer is made of a thermoplastic material like polyolefins, polyesters, polyamides.

According to an exemplary embodiment, the core layer is made of an elastomer material like polyacrylates, rubbers, silicones, etc. In this case the advantage would be to achieve higher damping factors at costs of lower bending stiffness.

According to an exemplary embodiment, the core layer is made of a thermoset material, like epoxy resins, polyester resins, polyurethanes, polyimides.

According to an exemplary embodiment, the first skin layer, the second skin layer and the core layer form a stack having an area density lower than 150 g/m2.

According to an exemplary embodiment, the first skin layer, the second skin layer and the core layer form a stack having a total thickness lower than 150 μm.

According to an exemplary embodiment, the first skin layer, the second skin layer and the core layer form a stack having a bending modulus higher than 10 GPa, in particular more than 20 GPa, further in particular more than 30 GPa.

According to an exemplary embodiment, the first skin layer, the second skin layer and the core layer form a stack extending within a plane. In other words, the membrane plate structure has a flat, uncurved shape extending along the plane.

According to an exemplary embodiment, the first skin layer, the second skin layer and the core layer form a stack having a curved, in particular wavelike, or dish (trapezoid) like, or dome like, or conus like extension. In other words, the membrane plate structure comprises a curved, wavelike, or dished (trapezoid) like, or dome like or conus like structure and runs not within a plane.

According to an exemplary embodiment, the first skin layer, the second skin layer and the core layer form (of a formed stack) having a total depth of less than ⅕, in particular 1/10, further in particular 1/20, of a largest width of the stack.

According to an exemplary embodiment, the material can be produced through a cold lamination process.

According to an exemplary embodiment, the material can be produced through a lamination process of thermoplastic core between two skin layers, at a temperature higher than the melting point of the core layer and lower than then the melting point of the skin layer.

According to an exemplary embodiment, to facilitate the lamination process at lower temperatures, the thermoplastic core has a melting point lower than 200° C., lower than 180° C., lower than 150° C.

According to an exemplary embodiment, the material can be produced with the application of a resin on one skin layer, the covering of the resin with second skin layer, and the curing of the resin.

It has to be noted that embodiments of the invention have been described with reference to different subject matters. In particular, some embodiments have been described with reference to apparatus type claims whereas other embodiments have been described with reference to method type claims. However, a person skilled in the art will gather from the above and the following description that, unless other notified, in addition to any combination of features belonging to one type of subject matter also any combination between features relating to different subject matters, in particular between features of the apparatus type claims and features of the method type claims is considered as to be disclosed with this application.

### EXAMPLES AND COMPARISON

As comparison of the possible advantages of the membrane plate structure comprising the sandwich material comprising the pores-free core layer, a summary table of the measured values of CIMERA® AD60-8H, compared to standard material is presented.

TABLE 1

| | | | | | Area density |
|---|---|---|---|---|---|
| | | | | Frequency | at ~same |
| | Young | | | Factor | Frequency |
| | Modulus | Density | Loss | at 60 μm | factor |
| Material | [GPa] | [g/cm³] | Factor | [m²/s] | [g/m²] |
| Aluminum | 70 | 2.7 | 0.0005 | 0.306 | 176 |
| | | | | | (@65 μm) |
| PEN | 7 | 1.35 | 0.05 | 0.127 | 218 |
| | | | | | (@ 160 μm) |
| CIMERA ® | 43 | 1.28 | 0.03 | 0.333 | 85 |
| AD60-8H | | | | | (@60 μm) |

As possible to observe, CIMERA® AD60-8H, an example of the pores-free sandwich material for the core layer, thanks to its sandwich structure at low thickness may outperform all the standard materials, both at same thickness and same weight. CIMERA is a registered trademark of 4A Manufacturing GmbH of Traboch, Austria.

### BRIEF DESCRIPTION OF THE DRAWINGS

The aspects defined above and further aspects of the present invention are apparent from the examples of embodiment to be described hereinafter and are explained with reference to the examples of embodiment. The invention will be described in more detail hereinafter with reference to examples of embodiment but to which the invention is not limited.

FIG. 1 shows a schematic view of a loudspeaker comprising the membrane plate structure according to an exemplary embodiment of the present invention, wherein the membrane plate structure comprises a flat shape.

FIG. 2 shows a schematic view of a loudspeaker comprising the membrane plate structure according to an exemplary embodiment of the present invention, wherein the membrane plate structure comprises a wavelike shape.

FIG. 3 shows a cross-sectional view of a loudspeaker of FIG. 1.

FIG. 4 shows a schematic view of a loudspeaker installed within a component carrier according to an exemplary embodiment of the present invention.

FIG. 5 shows a diagram illustrating sound pressure levels with respect to respective frequencies of two exemplary loudspeakers, one comprising a membrane plate made of AD70-8H pore-free sandwich construction and the other one an aluminum 50 μm flat plate.

### DETAILED DESCRIPTION OF ILLUSTRATED EMBODIMENTS

The illustrations in the drawings are schematically presented. It is noted that in different figures similar or identical elements are provided with the same reference signs.

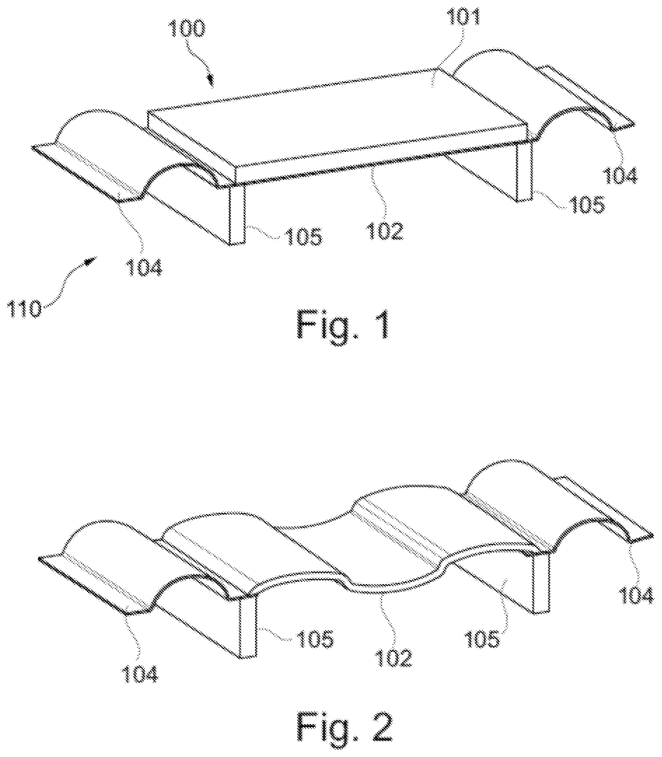

FIG. 1 shows a schematic view of a loudspeaker 110 comprising the membrane plate structure 100 according to an exemplary embodiment of the present invention. The loudspeaker 110 comprises a carrier element 104, a coil 105 which is coupled to the carrier element 104 and a membrane plate structure 100. The membrane plate structure 100 is supported by the carrier element 104 such that the membrane plate structure 100 is excitable by the coil 105 for generating sound waves.

The membrane plate structure 100 comprises a first skin layer 101, a second skin layer 102 and a core layer 103 which is interposed between the first skin layer 101 and the second skin layer 102. The young modulus of the core layer 103 is lower than the young modulus of the first skin layer 101 and the second skin layer 102. The density of the first skin layer 101 and/or the second skin layer 102 is higher than the density of the core layer 103. The core layer 103 is made of a material which is free of pores.

The coil may be electrically excited by a control unit (not shown). The membrane plate structure 100 is coupled to the coil 105 such that the excited coil excites the membrane plate structure 100 as well. The membrane plate structure 100 vibrates in an excited state and thereby generates acoustic sound.

The core layer 102 is formed with a lower young modulus than the surrounding skin layers 101, 102. Hence, the membrane plates 101, 102 are stiffer than the core layer 103. This combination of layers generates efficient acoustic sound waves.

In order to provide a very thin design of the membrane plate structure, the core layer 103 is, free of pores. Specifically, the core layer material is free of any pores which have a size of more than 1 μm (micrometre).

The membrane plate structure 100 according, to the exemplary embodiment shown in FIG. 1 has a flat and uncurved design. The first skin layer 101, the second skin layer 102 and the core layer 103 form a stack extending within a plane. In other words, the membrane plate structure 100 has a flat, uncurved shape extending along the plane. More specifically, the first skin layer 100, the second skin layer 102 and the core layer 103 extend along respective planes having parallel plane normals.

FIG. 2 shows an exemplary embodiment of a loudspeaker 110 having the same features as the loudspeaker 110 shown in FIG. 1, except that the membrane plate structure 100 has a curved shape. In particular, the first skin layer 101, the second skin layer 102 and the core layer 103 form a stack having a curved, in particular wavelike, extension. In other words, the membrane plate structure 100 comprises a curved, wavelike structure and runs not within a plane.

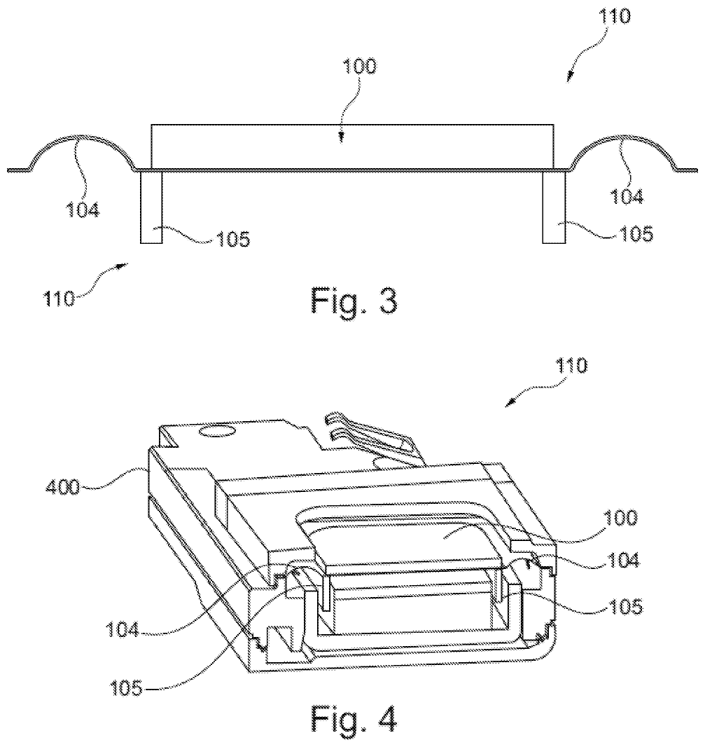

FIG. 3 shows a cross-sectional view of a loudspeaker of FIG. 1. This can be taken from FIG. 3, the carrier structure 100 for is coupled to the coil 105 and the membrane plate structure 100. The first skin layer 101, the second skin layer 102 and the core layer 103 form a stack having a total thickness of the lower than 150 μm.

FIG. 4 shows a schematic view of a loudspeaker 110 installed within a component carrier 400 according to an exemplary embodiment of the present invention. The loudspeaker 110 in FIG. 4 is for example an earpiece speaker. The carrier element 104 forms a stiff structure which supports the membrane plate structure 100. The loudspeaker 110 can further be fixed by the carrier element 104 to a further electronic component 400 (e.g. a printed circuit board).

The term substrate may particularly denote a small component carrier element having substantially the same size as an electronic component (i.e. the loudspeaker) to be mounted thereon.

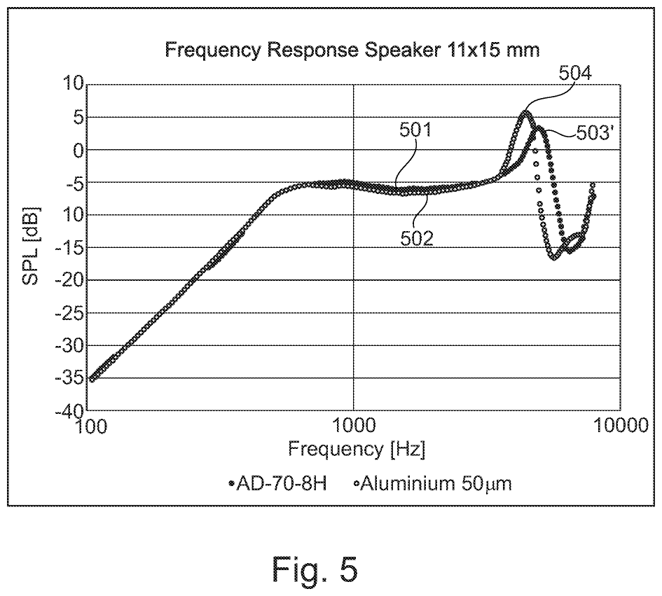

FIG. 5 shows a diagram illustrating sound pressure levels (SPL) [dB] with respect to respective frequencies [Hz] of two exemplary loudspeakers, one comprising a membrane plate made of AD70-8H pore-free sandwich construction according to the present invention and the other one an Aluminum 50 μm thick flat plate.

| | Young | | | Area | Frequency |
|---|---|---|---|---|---|
| | Modulus | Density | Loss | Density | Factor |
| Material | [GPa] | [g/cm₃] | Factor | [g/m₂] | [m₂/s] |
| Aluminum | 70 | 2.7 | 0.0005 | 135 | 0.26 |
| 50 μm | | | | | |
| CIMERA ® | 43 | 1.33 | 0.03 | 90 | 0.35 |
| AD70-8H | | | | | |
| 70 μm | | | | | |

Line 501 describes a relation between the SPL and a frequency of a first loudspeaker having a size of 11×15 mm and comprising a membrane plate 100 made of CIMERA® AD70-8H structure having a thickness of 70 μm (Micrometer). The material characteristics are described in table 2.

Line 502 describes a relation between the SPL and a frequency of a second loudspeaker having, a size of 11×15 mm and comprising a flat aluminum plate having a thickness of 50 μm. The material characteristics are described in table 2.

The first loudspeaker comprises the membrane structure 100 made of CIMERA® AD70-8H which is a pore-free sandwich construction of a total thickness of 70 μm with 8 μm of aluminum skin layer 101, 102, representative of the material proposed in claim 1. On Table 2 is possible to compare the mechanical properties of the two membrane structures 100. As possible to observe from the response curve 501 presented in FIG. 5, even if the CIMERA® AD70-8H membrane structure 100 presents less mass compared to the aluminum plate, the break-up frequency 503 of the CIMERA® AD70-8H membrane structure 100 is higher than the break-up frequency 504 of the aluminum plate.

It should be noted that the term “comprising” does not exclude other elements or steps and “a” or “an” does not exclude a plurality. Also elements described in association with different embodiments may be combined.

### LIST OF REFERENCE SIGNS

100 membrane plate
101 first skin layer
102 second skin layer
103 core layer
104 carrier element, membrane or surround
105 coil
110 loudspeaker
400 component carrier
501 Line 1
502 Line 2
503 break-up frequency Line 1
504 break-up frequency Line 2

1. A membrane plate structure for generating sound waves, the membrane plate structure comprising:
a first skin layer,
a second skin layer, and
a core layer which is interposed between the first skin layer and the second skin layer and binding the first skin layer and the second skin layer wherein:
at least one of the first skin layer and the second skin layer is coupleable to a vibrating element for generating sound waves,
a young modulus of the core layer is lower than a young modulus of the first skin layer and the second skin layer,
a density of the first skin layer and/or the second skin layer is higher than a density of the core layer,
the core layer is made of a material which is free of pores.

2. The membrane plate structure according to claim 1,
wherein a heat deflection temperature is higher than 80° C.

3. The membrane plate structure according to claim 1,
wherein the core layer is a plastic core layer.

4. The membrane plate structure according to claim 1,
wherein the core layer comprises an elastic modulus of more than 10 MPa.

5. The membrane plate structure according to,
wherein the first skin layer and/or the second skin layer comprise(s) an elastic modulus of more than 10 GPa.

6. The membrane plate structure according to,
wherein the first skin layer and/or the second skin layer is made of metal foil with a thickness lower than 15 μm.

7. The membrane plate structure according to claim 6,
wherein the core layer is made of one of a thermoplastic, an elastomeric plastic material, and a thermoset material.

8.-9. (canceled)

10-24. (canceled)

25. A membrane plate structure for generating sound waves, the membrane plate structure comprising:
a first skin layer,
a second skin layer, and
a core layer which is interposed between the first skin layer and the second skin layer and binding the first skin layer and the second skin layer wherein:
at least one of the first skin layer and the second skin layer is coupleable to a vibrating element for generating sound waves,
a young modulus of the core layer is lower than a young modulus of the first skin layer and the second skin layer,
a density of the first skin layer and/or the second skin layer is higher than a density of the core layer,
the core layer is made of a material which is free of pores.

26. The membrane plate structure according to claim 25, wherein a heat deflection temperature is higher than 80° C.

27. The membrane plate structure according to claim 25, wherein the core layer is a plastic core layer.

28. The membrane plate structure according to claim 25, wherein the core layer comprises an elastic modulus of more than 10 MPa.

29. The membrane plate structure according to claim 25, wherein the first skin layer and/or the second skin layer comprise(s) an elastic modulus of more than 10 GPa.

30. The membrane plate structure according to claim 25, wherein the first skin layer and/or the second skin layer is made of metal foil with a thickness lower than 15 μm.

31. The membrane plate structure according to claim 30, wherein the core layer is made of one of a thermoplastic, an elastomeric plastic material, and a thermoset material.

32. The membrane plate structure according to claim 25, wherein the first skin layer, the second skin layer and the core layer form a stack having an area density lower than 150 g/m2.

33. The membrane plate structure according to claim 25, wherein the first skin layer, the second skin layer and the core layer form a stack having a total thickness lower than 150 μm.

34. The membrane plate structure according to claim 25, wherein the first skin layer, the second skin layer and the core layer form a stack having a bending modulus higher than 10 GPa.

35. The membrane plate structure according to claim 25, wherein the first skin layer, the second skin layer and the core layer form a stack extending within a plane.

36. The membrane plate structure according to claim 25,
wherein the first skin layer, the second skin layer and the core layer are ductile materials, and
wherein the first skin layer, the second skin layer and/or the core layer are made of materials which are cold/warm formable.

37. The membrane plate structure according to claim 25, wherein the first skin layer, the second skin layer and the core layer form a stack having a curved extension.

38. The membrane plate structure according to claim 37, wherein the first skin layer, the second skin layer and the core layer form a stack having a forming depth of less than ⅕ of a largest width of the stack.

39. The membrane plate structure according to claim 25, wherein the core layer has a material with a melting temperature lower than 200° C.

40. A micro speaker comprising a membrane plate structure with a first skin layer, a second skin layer, and
a core layer which is interposed between the first skin layer and the second skin layer and binding the first skin layer and the second skin layer wherein:
at least one of the first skin layer and the second skin layer is coupleable to a vibrating element for generating sound waves,
a young modulus of the core layer is lower than a young modulus of the first skin layer and the second skin layer,
a density of the first skin layer and/or the second skin layer is higher than a density of the core layer,
the core layer is made of a material which is free of pores,
a thickness of the micro speaker is less than 2.5 mm.

41. A method, comprising:
providing a first skin layer and a second skin layer,
providing a pore free core layer;
binding the first skin layer and the second skin layer to opposed surfaces of the pore free core layer; and
coupling at least one of the first skin layer and the second skin layer to a vibration generator;
wherein a young modulus of the pre free core layer is lower than a young modulus of the first skin layer and the second skin layer,
a density of the first skin layer and/or the second skin layer is higher than a density of the core layer.

42. The method of claim 41, wherein the first skin layer, the second skin layer and the core layer are joined through an ambient temperature lamination step.

43. The method of claim 41,
wherein the first skin layer and the second skin layer and the core layer, are joined through a lamination step at a temperature higher than 50° C.;
with the core layer being a thermoplastic;
wherein respective temperatures of the first skin layer, the second skin layer and the core layer are higher than a melting temperature of the core layer and lower than a respective melting temperature of the first skin layer and the second skin layer.

44. The method of claim 41, wherein the membrane plate structure is made of a composite material produced by depositing a resin as core layer on the first skin layer, covering the resin with the second skin layer and curing the resin.
